(19) United States
(12) Patent Application Publication
(10) Pub. No.: US 2007/0266419 A1
(43) Pub. Date: Nov. 15, 2007

(54) Digital television signal, digital television receiver, and method for processing digital television signal

(76) Inventor: Jin Pil Kim, Seoul (KR)

Correspondence Address: MCKENNA LONG & ALDRIDGE LLP, 1900 K STREET, NW, WASHINGTON, DC, 20006, US

(21) Appl. No.: 11/600,115

(22) Filed: Nov. 16, 2006

Related U.S. Application Data
(60) Provisional application No. 60/800,042, filed on May 15, 2006.

(30) Foreign Application Priority Data
May 15, 2006 (KR) 10-2006-0043608

(51) Int. Cl. H04N 7/16; H04N 7/173; H04N 5/445; G06F 13/00; G06F 3/00

(52) U.S. Cl. 725/135; 725/90; 725/45; 725/136

(57) ABSTRACT

A digital television signal, a digital television receiver, and a method for processing a digital television signal are disclosed, which can solve problems encountered when only general broadcast programs are defined as events on a PSIP. The digital television receiver includes a tuner for receiving a digital television signal including an EIT carrying information for events on defined virtual channels, a demodulator arranged to demodulate the signal, a demultiplexer for demultiplexing the EIT from the signal demodulated by the demodulator, a decoder for parsing the EIT, the parsed EIT including an event type field defining an actual event, a dummy event, wherein the dummy event corresponds to an undecided domain on an EPG, and a controller arranged to store the parsed EIT in a database.

This application claims the benefit of the Korean Patent Application No. 10-2006-0043608, filed on May 15, 2006, which is hereby incorporated by reference as if fully set forth herein. This application also claims the benefit of U.S. Provisional Application No. 60/800,042, filed on May 15, 2006, which is hereby incorporated by reference.

### BACKGROUND OF THE INVENTION

1. Field of the Invention

The present invention relates to digital broadcast technology, and more particularly to a digital television signal, a digital television receiver, and a method for processing a digital television signal, which can define not only general broadcast programs but also undecided domains (e.g., advertisement broadcast programs, software (S/W) programs, data broadcast programs, or other transmission states having no broadcast signal, etc.) on an EPG (Electronic Program Guide) as additional events, and can easily and separately manage all the broadcast signals.

2. Discussion of the Related Art

Typically, a Program and System Information Protocol (PSIP) is an Advanced Television System Committee (ATSC) standard for terrestrial and cable digital broadcast technologies.

The PSIP transmits broadcast signals encoded by an MPEG-2 system (e.g., ISO/IEC 13818-1 system) are transmitted to a broadcast receiver. A digital TV performs parsing of the encoded broadcast signals, and displays a variety of programs.

The PSIP can transmit/receive Audio/Video (A/V) data configured in the form of MPEG-2 video data and AC-3 audio format. The PSIP includes a variety of tables capable of transmitting information of channels of individual broadcast stations and each program of the channel, etc.

For example, the PSIP can provide additional services (e.g., A/V service and EPG (Electronic Program Guide), etc.) using tables such as an MGT (Master Guide Table), etc.

Specifically, the PSIP can provide users with a variety of information associated with each of numerous events via the EPG service, etc.

However, the term “event” of the above-mentioned PSIP is indicative of a broadcast program unit. For example, individual broadcast programs (e.g., drama1, movie2, and news1) configure a single event.

The EPG is indicative of a program schedule including program- and summary-data of individual channels.

The EPG serves as an electronic guide equal to a printed television (TV) program guide, and is generally controlled by a remote controller. Besides, the EPG may order a pay-per-view program, may search for programs for each theme or category, and may record video data, etc.

However, the above-mentioned conventional digital broadcast technology has the following disadvantages.

Conventionally, the conventional digital broadcast technology has defined only general broadcast programs (e.g., drama1, movie2, and news1, etc.) as events, and has provided users with EPG information of the defined broadcast programs, such that it cannot additionally manage broadcast signals other than the above-mentioned general broadcast programs.

### SUMMARY OF THE INVENTION

Accordingly, the present invention is directed to a digital television signal, a digital television receiver, and a method for processing a digital television signal that substantially obviate one or more problems due to limitations and disadvantages of the related art.

An object of the present invention is to provide a digital television signal, a digital television receiver, and a method for processing digital television signal, which can define not only general broadcast programs but also undecided domains (e.g., advertisement broadcast programs, software (S/W) programs, data broadcast programs, or other transmission states having no broadcast signal, etc.) on an EPG (Electronic Program Guide) as additional events, and can easily and separately manage all the broadcast signals.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a digital television signal for use in a digital television receiver for receiving program and system information protocol data from a broadcast transmitter, the digital television signal comprising an event information table carrying information for events on defined virtual channels, wherein the event information table includes: an event type field defining an actual event that is a collection of associated television program elements that have a common timeline for a defined period, and a dummy event that is a collection of unassociated television program elements that have a common timeline for a defined period, wherein the dummy event corresponds to an undecided domain on an electronic program guide.

In another aspect of the present invention, there is provided a digital television signal for use in a digital television receiver for receiving program and system information protocol data from a broadcast transmitter, the digital television signal comprising an event information table carrying information for events on defined virtual channels, wherein the event information table includes: an event type field defining an actual event that is a collection of associated television program elements that have a common timeline for a defined period, and a dummy event that is a collection of unassociated television program elements that have a common timeline for a defined period, wherein the dummy event corresponds to at least one of an advertisement broadcast program, a broadcast program having downloadable S/W, a broadcast program having only at least one of data service, and no broadcast signal.

In yet another aspect of the present invention, there is provided a method for processing a digital television signal in a television receiver, the method comprising: receiving a digital television signal including an event information table carrying information for events on defined virtual channels; parsing the event information table, the parsed event information table including an event type field defining an actual event that is a collection of associated television program elements that have a common timeline for a defined period, and a dummy event that is a collection of unassociated television program elements that have a common timeline for a defined period, wherein the dummy event corresponds to an undecided domain on an electronic program guide; and storing the parsed event information table in a database.

In yet another aspect of the present invention, there is provided a method of processing a digital television signal in a television receiver, the method comprising: receiving a digital television signal including an event information table carrying information for events on defined virtual channels; parsing the event information table, the parsed event information table including an event type field defining an actual event that is a collection of associated television program elements that have a common timeline for a defined period, and a dummy event that is a collection of unassociated television program elements that have a common timeline for a defined period, wherein the dummy event corresponds to at least one of an advertisement broadcast program, a broadcast program having downloadable S/W, a broadcast program having only at least one of data service, and no broadcast signal; and storing the parsed event information table in a database.

In yet another aspect of the present invention, there is provided a digital television receiver comprising: a tuner arranged to receive a digital television signal including an event information table carrying information for events on defined virtual channels; a demodulator arranged to demodulate the digital television signal; a demultiplexer arranged to demultiplex the event information table from the digital television signal demodulated by the demodulator; a decoder arranged to parse the event information table, the parsed event information table including an event type field defining an actual event that is a collection of associated television program elements that have a common timeline for a defined period, and a dummy event that is a collection of unassociated television program elements that have a common timeline for a defined period, wherein the dummy event corresponds to an undecided domain on an electronic program guide; and a controller arranged to store the parsed event information table in a database.

In yet another aspect of the present invention, there is provided a digital television receiver comprising: a tuner arranged to receive a digital television signal including an event information table carrying information for events on defined virtual channels; a demodulator arranged to demodulate the digital television signal; a demultiplexer arranged to demultiplex the event information table from the digital television signal demodulated by the demodulator; a decoder arranged to parse the event information table, the parsed event information table including a title text field specifying a theme of a dummy event by a text mode, wherein the dummy event is a collection of unassociated television program elements that have a common timeline for a defined period, and corresponds to an undecided domain on an electronic program guide; and a controller arranged to store the parsed event information table in a database.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is an example of a general actual event displayed on an EPG;

FIG. 2 is an example of a dummy event displayed on an EPG according to the present invention;

FIG. 3 is an example of a bit stream syntax of an Event Information Table (EIT) according to the present invention;

FIG. 4 is another example of a bit stream syntax of an EIT according to the present invention;

FIG. 5 is an example of a bit assignment method of an “event_type” field of the EIT according to the present invention;

FIG. 6 is an example of a “title_text( )” field of the EIT according to the present invention;

FIG. 7 is an example of a “Dummy_event_descriptor” field of the EIT according to the present invention;

FIG. 8 is an example of a “num_events_in_section” field of the EIT according to the present invention;

FIG. 9 is a block diagram illustrating a broadcast receiver for receiving/processing information of the EIT according to the present invention; and

FIG. 10 is a flow chart illustrating a method for controlling a broadcast receiver for receiving/processing information of the EIT according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

The present invention relates to a digital television signal, a digital television receiver, and a method for processing a digital television signal, such that a user of a TV (e.g., a Digital TV (DTV)) can easily distinguish undecided domains on an EPG (e.g., advertisement broadcast programs, test broadcast programs, data broadcast programs, and other broadcast programs associated with S/W download, etc.) from general broadcast programs (e.g., drama, news, and movie programs).

In addition, the present invention allows the user to easily recognize or view EPG data of undecided domains on the EPG, and also allows the user to easily determine whether to record the EPG data of the undecided domains.

Prior to describing the present invention, it should be noted that the present invention is classified into first, second, third, fourth, fifth, sixth, and sixth preferred embodiments, and detailed descriptions thereof will hereinafter be described in detail.

The first preferred embodiment relates to definition and usages of a dummy event according to the present invention.

The second preferred embodiment relates to a first method for defining the dummy event using the EIT (Event Information Table).

The third preferred embodiment relates to a second method for defining the dummy event using the EIT.

The fourth preferred embodiment relates to a third method for defining the dummy event using the EIT.

The fifth preferred embodiment relates to a fourth method for defining the dummy event using the EIT.

The sixth preferred embodiment relates to a broadcast receiver for receiving/processing the EIT.

The seventh preferred embodiment relates to a method for controlling the broadcast receiver capable of receiving/processing the EIT.

### First Preferred Embodiment

FIG. 1 is an example of a general actual event displayed on an EPG.

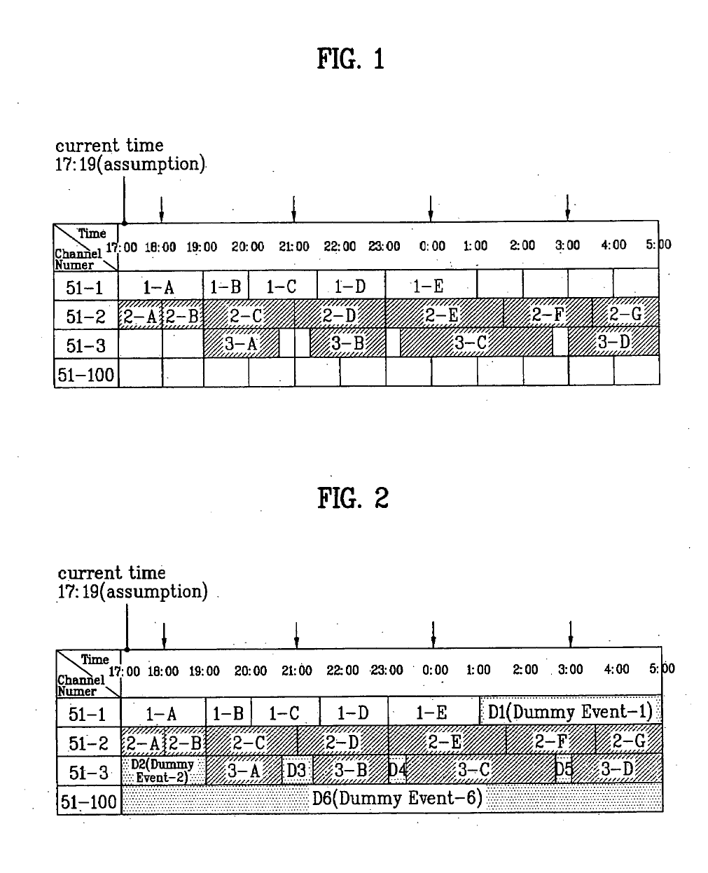

FIG. 2 is an example of a dummy event displayed on an EPG according to the present invention.

Definition and usages of the dummy event according to the present invention will hereinafter be described with reference to FIGS. 1 and 2.

FIG. 1 shows time-flow information of an actual event broadcast to a virtual channel. However, a detailed description of the actual event will be described at a later time for better understanding of the present invention.

FIG. 1 shows a program scheduling guide of a predetermined broadcast time from 17:00 to 05:00 (e.g., 17:00 today to 05:00 tomorrow) of a broadcast program, which is broadcast from a single physical channel to four virtual channels.

In this case, the physical channel serves as a major channel, and the major channel number is “51”. The virtual channels serves as minor channels, and the minor channel numbers are “1”, “2”, “3”, and “100”.

The above-mentioned program scheduling guide is called an Electronic Program Guide (EPG).

Referring to FIG. 1, reference numerals ‘1-A’, ‘1-B’, ‘1-C’, ‘1-D’, and ‘1-E’ are indicative of titles of programs to be broadcast via a specific channel “51-1”.

The remaining numerals ‘2-A’, ‘2-B’, ‘2-C’, ‘2-D’, ‘2-E’, ‘2-F’, ‘2-G’, ‘3-A’, ‘3-B’, ‘3-C’, and ‘3-D’ also indicate titles of programs to be broadcast via corresponding virtual channels.

Curve-ended arrow marks depicted at an upper left side of FIG. 1 indicate current time information, and the current time information is received or stored via a System Time Table (STT).

Sharp-ended arrow marks depicted at an upper side of FIG. 1 indicate time domains of an event included in a single EIT-k from among a plurality of EIT-k (where, k=1˜127) values.

In more detail, it is assumed that a total of eight absolute times (e.g., 0:00, 3:00, 6:00, 9:00, 12:00, 15:00, 18:00, and 21:00) exist in 24 hours in a day.

As can be seen from FIG. 1, substantial broadcast channels are the “51-1” channel and the “51-2” channel on the basis of a current time “17:19”.

The above-mentioned substantial broadcast channels are called active channels or active virtual channels.

The above-mentioned “51-1” channel has no broadcast data at a specific time “1:00”, such that it is transitioned from the active channel to an inactive channel at the specific time “1:00”.

The above-mentioned “51-3” channel will broadcast a general broadcast program “3-A” from 19:00, however, it can be considered to be an inactive channel on the basis of a current time 17:19.

In the meantime, empty spaces among general broadcast programs “3-A”, “3-B”, “3-C”, and “3-D” indicate advertisement broadcast programs, etc.

The above-mentioned general broadcast program generally indicates A/V broadcast signals transmitted from broadcast stations.

The above-mentioned general broadcast program may also indicate regular broadcast programs to be broadcast by the broadcast stations.

For example, the above-mentioned general broadcast programs may correspond to drama1, sports2, movie1, or news1, etc.

The “51-100” channel indicates a dedicated channel for data broadcast (also called a data broadcast dedicated channel) having no A/V data. Conventionally, a system must not use the EIT in association with service-type virtual channels having no A/V data.

Each channel “1-A”, “1-B”, . . . , or “3-D” indicate a broadcast program. Particularly, the channel “1-A”, “A1-B”, . . . , or “3-D” may also indicate a general broadcast program as necessary.

As described above, events associated with substantially-broadcasting broadcast programs are defined as actual events.

The actual event indicates a collection of associated television program elements that have a common timeline for a defined period. The actual event is equivalent to the common industry usage of television program. The actual event may also be an analog television program.

The actual event is indicative of an event contained in the EIT of the PSIP, and serves as a general television program unit capable of including a variety of information (e.g., event title data, event start time data, event duration data, caption data, and rating data, etc.)

In this case, the event title data indicates a title of a broadcast program. The event start time data indicates a start time of the broadcast program. The event duration data indicates a duration time of the broadcast program.

In the meantime, as shown in FIG. 1, the time zone from 17:00 today to 4:00 tomorrow has some empty spaces unfilled with the actual events.

The above-mentioned empty spaces indicate time zones incapable of transmitting general broadcast programs. It should be noted that the aforementioned empty spaces are defined as dummy events according to the present invention.

The above-mentioned dummy event will be described in detail with reference to FIG. 2.

The dummy event is a virtual event for indicating empty time zones unfilled with the actual events in a broadcast information time zone such as the EPG.

FIG. 2 is an example of the dummy event, and shows a total of 6 dummy events from D1 to D6 for better understanding of the present invention.

In brief, the actual event is a regular broadcast program unit transmitted from the broadcast station.

In order to distinguish between the actual event and the dummy event, the present invention assumes that the above-mentioned actual event corresponds to a general broadcast program unit.

In the meantime, the dummy event indicates the remaining events other than the actual event.

In other words, the dummy event indicates a collection of unassociated television program elements that have a common timeline for a defined period.

For example, the dummy event indicates an inactive channel state, an advertisement broadcast transmission state, and transmission states of other special broadcast signals (e.g., broadcast signals transmitted via a data dedicated channel and a software (S/W) download channel, etc.)

In order to distinguish between the dummy event and the actual event, the present invention assumes that the dummy event corresponds to an undecided domain on the EPG.

Therefore, the dummy event is distinguished from the actual event (e.g., news1, drama2, movie1, and documentary1, etc.). For example, the dummy event indicates an inactive channel state, an advertisement broadcast transmission state, and transmission states of other broadcast signals.

For example, it is assumed that the movie entitled “Mission Impossible III” will be broadcast by a specific broadcast station during a time zone from 22:00 to 23:50 on a weekend.

Considering substantial broadcast environments, it should be noted that an actual broadcast time of the above-mentioned movie “Mission Impossible III” is not exactly equal to 1 hour and 50 minutes, and but is approximately equal to the time of 1 hour and 50 minutes.

The reason why the actual broadcast time is slightly different from the above-mentioned time of 1 hour and 50 minutes is that a plurality of advertisement broadcast programs are attached before and after the broadcast program. Under the situations of specific countries' broadcast environments, advertisement broadcast programs may also be inserted into a specific broadcast program (e.g., a movie program) as necessary.

In this case, the above-mentioned movie program “Mission Impossible III” may be considered to be the actual event, and the above-mentioned advertisement broadcast program may also be considered to be the dummy event.

Although the above-mentioned example has used the advertisement broadcast program as the dummy event, it should be noted that the following first to third status events may also correspond to the dummy event according to broadcast receivers or broadcast stream contents.

According to the first status event of a first preferred embodiment of the present invention, a status of an inactive event (i.e., an inactive event status) is considered to be the dummy event.

Reference characters “D1” and “D2” of FIG. 2 correspond to the first preferred embodiment of the present invention.

According to the second status event of a second preferred embodiment of the present invention, a status of advertisement event (i.e., an advertisement event status) is considered to be the dummy event.

Reference characters “D3”, “D4” and “D5” of FIG. 2 correspond to the second preferred embodiment of the present invention.

According to the third status event of a third preferred embodiment of the present invention, either a status of only data broadcasting (i.e., a special-purpose data dedicated broadcast having no A/V data) or a status of S/W download channel (i.e., a S/W download signal transmission status) is considered to be the dummy event.

Reference character “D6” of FIG. 2 corresponds to the third preferred embodiment of the present invention.

The dummy event is newly defined as described above by the PSIP, such that it has the following effects.

If the inactive event status is considered to be the dummy event, a user can recognize when the active event will begin.

The user can pre-recognize no signal of the inactive channel, such that the user can immediately skip over a black image (or a black screen) of the inactive channel without watching the black image of the inactive channel.

The present invention can clearly distinguish between a first status, in which a broadcast receiver does not receive specific data from a broadcast station after the specific data has been transmitted from the broadcast station, and a second status in which no data is substantially transmitted, such that the user can definitely recognize the difference between the first and second statuses.

If the advertisement event status is considered to be the dummy event, the user can easily distinguish the advertisement broadcast programs from general broadcast programs (e.g., drama or news, etc.)

However, the conventional system has not defined detailed information indicating whether the advertisement broadcast program is contained in a specific event, such that the user is unable to correctly recognize the start and end times of a specific broadcast program, and the user has difficulty in reserving/recording a desired broadcast program using the EPG.

If the advertisement event status is condiered to be the dummy event, additional services (e.g., a DTVCC, rating information, and ac3 audio service, etc.) can be clearly defined.

If the special-purpose data dedicated broadcast having no A/V data or the S/W download signal transmission status is considered to be the dummy event, the event having no A/V signals can be clearly displayed on the EPG.

In more detail, the present invention can display a variety of characteristics of a specific S/W program, (e.g., a transmission time, a memory size, and other characteristics of the specific S/W program) on the EPG.

Furthermore, the present invention can effectively solve deployed DTV's backward compatibility with the EPG during the ACAP data broadcast time or the S/W download service.

According to conventional PSIP standards, EIT-0, 1, 2, and 3 standards act as mandatory elements, however, all the EIT standards (EIT-all) act as optional elements in association with No A/V event (i.e., an event having no A/V signals), such that unexpected confusion may occur in the broadcast receiver.

The present invention discloses a variety of methods for processing the above-mentioned dummy event separately from the actual event. The above-mentioned methods for processing the dummy event separately from the actual event will be described in detail with reference to the following second, third, and fourth preferred embodiments of the present invention.

### Second Preferred Embodiment

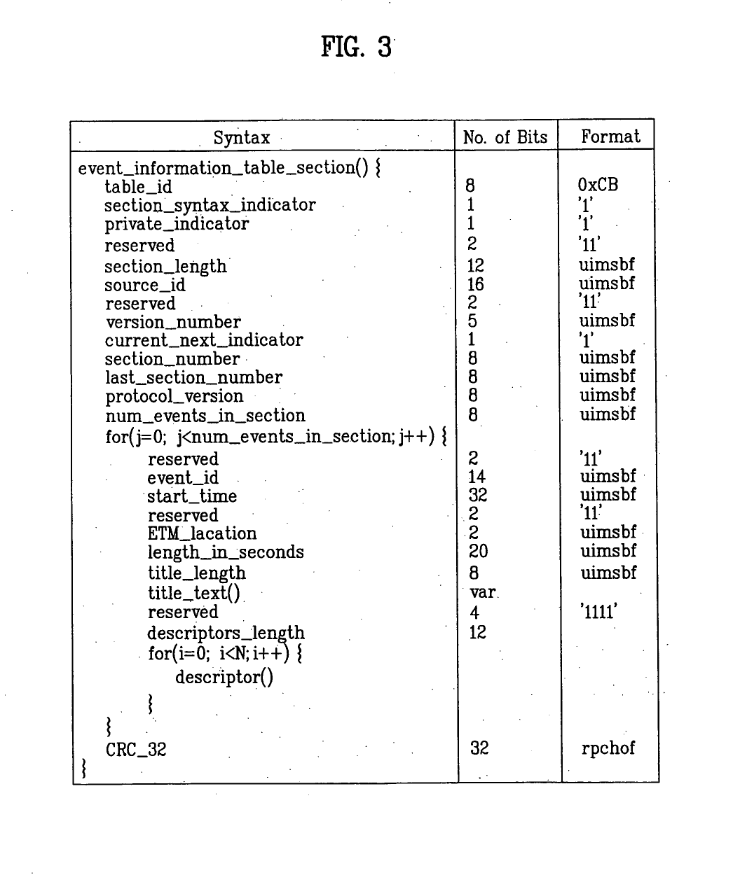

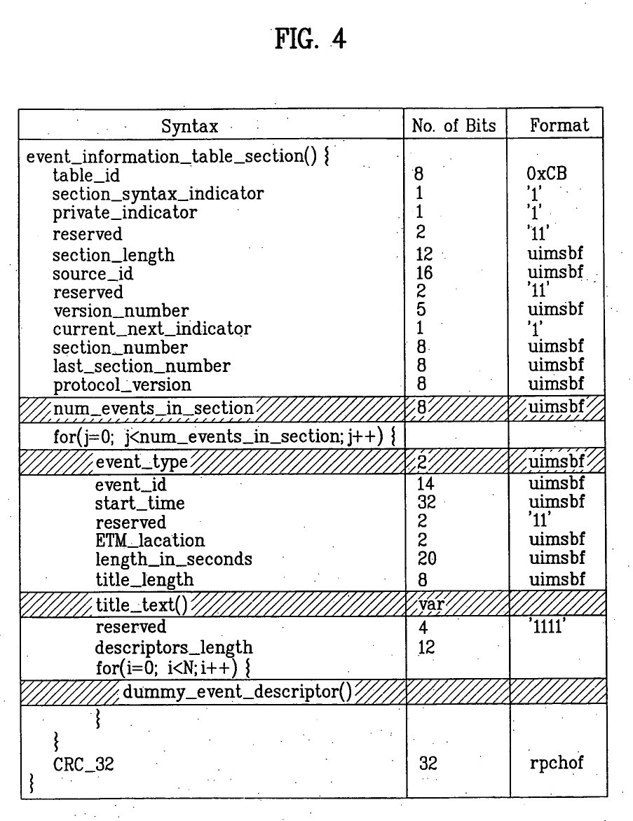

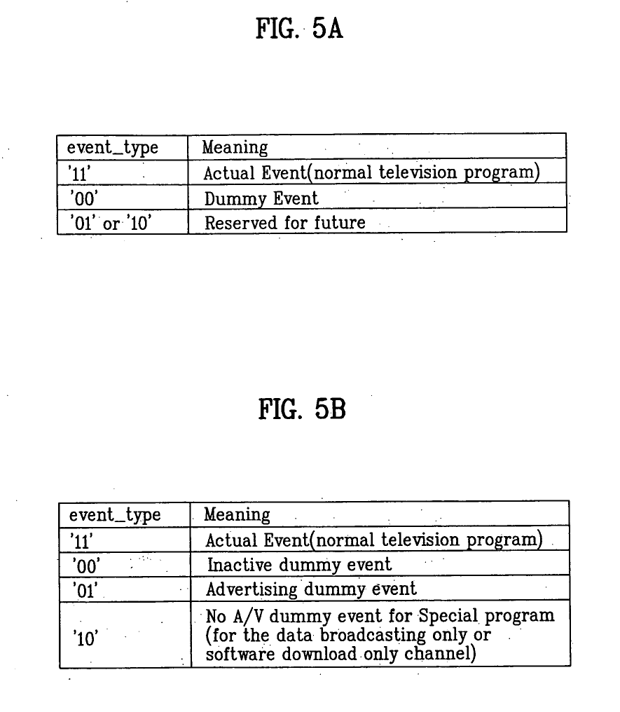

FIG. 3 is an example of a bit stream syntax of an Event Information Table (EIT) according to the present invention. FIG. 4 is another example of a bit stream syntax of an EIT according to the present invention. FIG. 5 is an example of a bit assignment method of an “event_type” field of the EIT according to the present invention.

A method for defining the dummy event using the EIT will hereinafter be described with reference to FIGS. 3, 4, and 5.

The EIT is an example of a variety of PSIP tables, each of which includes title- and start time-information of a virtual channel event.

However, it should be noted that the actual event and the dummy event will be defined as the above-mentioned event in different ways.

Referring to FIG. 3, the EIT includes a plurality of fields.

The “table_id” field is an 8-bit field which shall be set to 0×CB, identifying this section as belonging to the Event Information Table.

The “section_syntax_indicator” field is set to ‘1’. It denotes that the section follows the generic section syntax beyond the section length field.

The “private_indicator_field is set to ‘1’.

Although a plurality of fields are depicted in FIG. 3, it should be noted that only some critical fields will be described in detail, and the remaining fields other than the above-mentioned critical fields will herein be omitted for the convenience of description.

In FIG. 3, the “num_events_in_section” field indicates the number of events defined in the EIT-k (k=0-127).

The “for(j=0;j<num_events_in_section;j++){}” loop describes characteristics of individual events.

Specifically, in association with the present invention, a reserved field positioned under the “for(j=0;j<num_events_in_section;j++){}” syntax is defined as the “event_type” field of FIG. 4.

The “title_text( )” field is used as a text string capable of describing category, status, and characteristics of the dummy event.

The EIT's descriptor field of FIG. 3 is used as the “dummy_event_descriptor” field indicating the dummy event, as shown in FIG. 4, such that it can clearly describe more detailed information of the dummy event.

The second preferred embodiment of the present invention will describe a method for defining the dummy event information using the “event_type” field of FIG. 4.

The present invention is characterized in that the dummy event is distinguished from the actual event, and is more precisely classified.

If the “event_type” field has a specific value “11”, it is assumed that the “event_type” field of “11” indicates the actual event, resulting in the maintenance of backward compatibility.

The broadcast receiver recognizes the value of the “event_type” field of the EIT of FIG. 5, and determines category information of the dummy event, such that it can perform a variety of functions (e.g., an EPG display function, a viewing function, and a recording function, etc.) associated with the dummy event on the basis of the determined category information.

### Third Preferred Embodiment

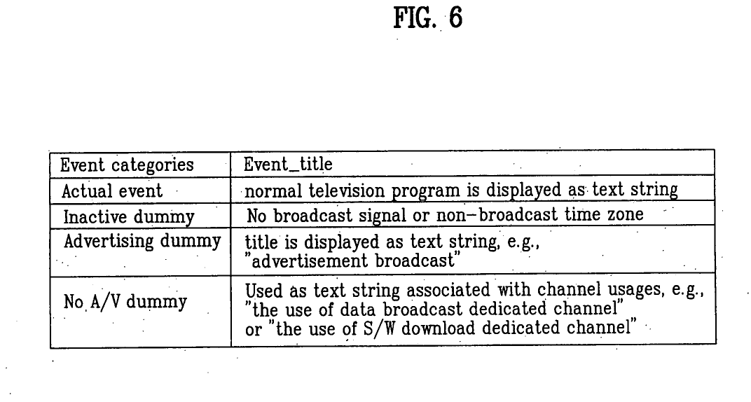

FIG. 6 is an example of a “title_text( )” field of the EIT according to a third preferred embodiment of the present invention.

Another method for defining the dummy event using the EIT according to the third preferred embodiment of the present invention will hereinafter be described with reference to FIGS. 6 and 4.

Although a dummy event occurs, the system according to the third preferred embodiment can normally transmit event-associated information instead of null data, in the same manner as in the actual event.

The system according to the third preferred embodiment of the present invention is characterized in that it can directly insert not only the title of the actual event but also text data indicating the dummy event status into the “title_text( )” field, such that it can transmit the resultant “title_text( )” data including the the title and text data of the actual event.

FIG. 6 exemplarily shows the “title_text( )” field capable of being displayed by the broadcast station according to dummy event categories. In this case, the “title_text( )” field of FIG. 6 is configured in the form of a table.

The third preferred embodiment relates to a method for allowing the broadcast station to directly insert a text string into the “title_text( )” field capable of explaining the corresponding event, such that the resultant “title_text( )” field including the text string is transmitted to a destination, whereas the second and fourth preferred embodiments relate to the method for distinguishing between the dummy event and the actual event, which are compared to each other, in the same manner as in the “event_type” field.

Besides, the third preferred embodiment can also implement the inventive method by changing only the “title_text( )” field to another field, without changing the “event_type” field of the second preferred embodiment and the “descriptor” field of the fourth preferred embodiment to others.

In more detail, according to the third preferred embodiment of the present invention, the broadcast station inserts inactive dummy event information (e.g., start time, and duration, etc.) capable of expressing a non-broadcast time zone into the EIT during the inactive broadcast status (e.g., momentary non-broadcast time zone), instead of inserting null data into the EIT, such that the inactive broadcast status is broadcast as if it were the active event.

However, it should be noted that specific text data (e.g., no broadcast data) is inserted into the event title.

Needless to say, although the above-mentioned preferred embodiments have exemplarily disclosed the dummy event, it should be noted that the present invention inserts additional descriptions (e.g., theme) of each dummy event into the “title_text( )” field in the case of other dummy events for transmitting advertisement broadcast signals, data dedicated broadcast signals, and S/W download signals, etc., as shown in FIG. 6.

Therefore, differently from the conventional art, the broadcast receiver according to the present invention can provide the EPG without generating empty spaces, and can allow the user to view contents of the event title “title_text( )” via the EPG, such that the user can recognize category information of a current dummy event via the EPG.

### Fourth Preferred Embodiment

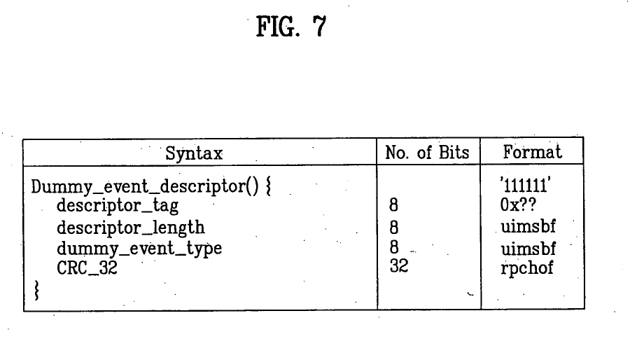

FIG. 7 is an example of a “Dummy_event_descriptor” field of the EIT according to a fourth preferred embodiment of the present invention.

A still another method for defining the dummy event using the EIT will hereinafter be described with reference to FIGS. 7 and 4.

In order to distinguish between the actual event and the dummy event, the fourth preferred embodiment relates to a method for defining a descriptor in the EIT and employing the defined descriptor. FIG. 7 shows an exemplary syntax for defining the “dummy_event_descriptor” field.

The “dummy_event_descriptor” field indicates whether individual events contained in the EIT have dummy event characteristics. If each event contained in the EIT is determined to be the dummy event, the “dummy_event_type” field indicates status information of the determined dummy event.

Although the above-mentioned “dummy_event_type” field is defined as a 8-bit field, it should be noted that the “dummy_event_type” field of 8 bits is used as an exemplary case for the convenience of description, and may also be configured as depicted in FIG. 5.

Operations of the broadcast receiver are equal to those of the method for distinctly processing the “event_type” field of the second preferred embodiment. However, the above-mentioned broadcast receiver according to the fourth preferred embodiment distinguishes between the dummy event and the actual event. If the dummy event is determined, a syntax used for the distinction of the dummy event may indicate whether the reserved field (See the second preferred embodiment) is extended, or the descriptor (See the fourth preferred embodiment) is extended.

### Fifth Preferred Embodiment

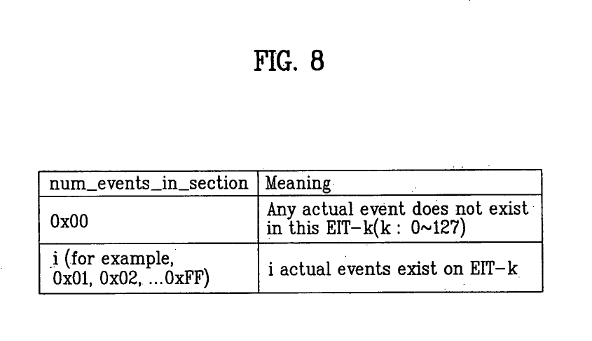

FIG. 8 is an example of a “num_events_in_section” field of the EIT according to a fifth preferred embodiment of the present invention.

A still another method for defining the dummy event using the EIT will hereinafter be described with reference to FIGS. 8 and 4.

In order to distinguish between the actual event and the dummy event, the fifth preferred embodiment relates to a method for newly defining the “num_events_in_section” field from among fields of the EIT. FIG. 8 shows an exemplary table in which values of the “num_events_in_section” field and meanings corresponding to the values are contained.

Referring to FIG. 8, if the “num_events_in_section” field has a specific value “0×00”, this field means that there is no actual event in the corresponding EIT-k.

For reference, the value of k ranges from 0 to 127.

Therefore, a 3-hour zone designated by the EIT-k indicates a dummy event zone.

Otherwise, if the “num_events_in_section” field has another value (e.g., the ‘i’ value) instead of the value “0×00”, this field means that i actual events exist in the EIT-K.

As described above, the actual event indicates an event associated with the normal television program, the dummy event indicates other events except for the actual event.

In more detail, the above-mentioned dummy event indicates an advertisement broadcast transmission status event, a S/W download signal transmission status event, a data dedicated broadcast transmission status event, and no broadcast signal transmission status event, etc.

For reference, the second preferred embodiment, the third preferred embodiment, the fourth preferred embodiment, and the fifth preferred embodiment may be operated independent of each other. Also, the second preferred embodiment may be interoperable with the third preferred embodiment as necessary, or the third preferred embodiment may be interoperable with the fourth preferred embodiment as necessary.

### Sixth Preferred Embodiment

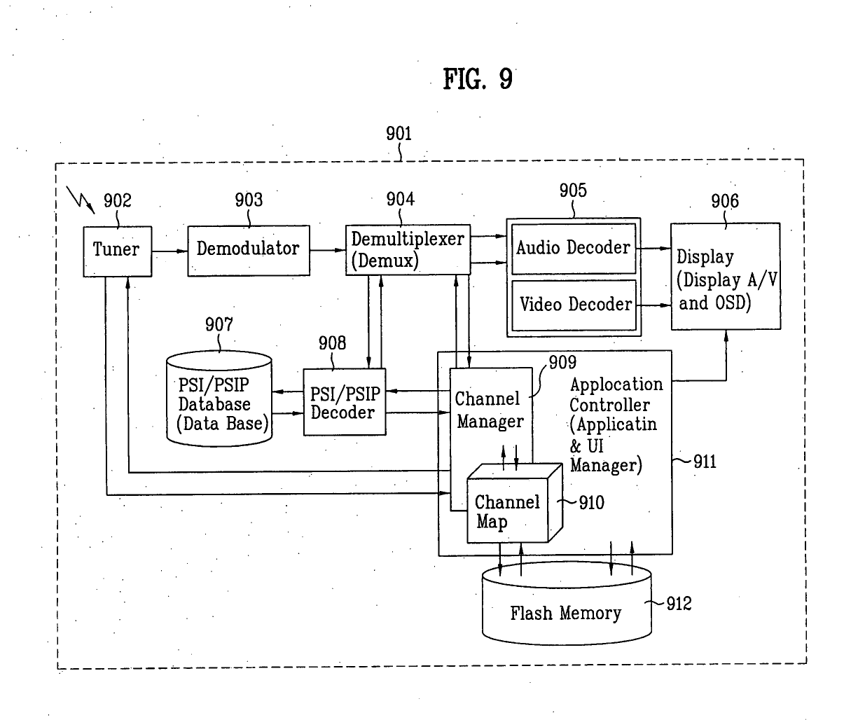

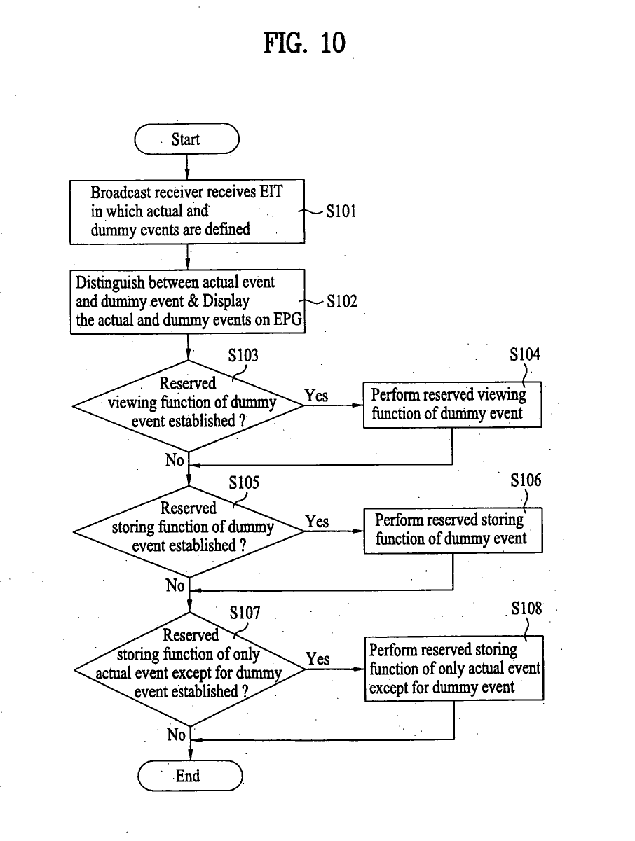

FIG. 9 is a block diagram illustrating a broadcast receiver for receiving/processing information of the EIT according to the present invention.

An example of the broadcast receiver for receiving/processing the EIT according to the present invention will hereinafter be described with reference to FIGS. 9 and 1˜8.

Referring to FIG. 9, the broadcast receiver 901 includes a tuner 902, a demodulator 903, a demultiplexer (Demux) 904, an A/V decoder, a display 906, a PSI/PSIP database (DB) 907, a PSI/PSIP decoder 908, a channel manager 909, a channel map 910, an application controller 911, and a flash memory 912, etc.

For example, the broadcast receiver 901 may be a digital TV (DTV) capable of receiving digital broadcast data.

The tuner 902 receives a digital broadcast signal including a PSI/PSIP (Program and System Information/Program and System Information Protocol) table.

Specifically, the PSI/PSIP table includes the EIT, etc.

The tuner 902 is controlled by the channel manager 909. The tuner 902 re-records the result of the received digital broadcast signal in the channel manager 909.

The demodulator 903 demodulates a signal tuned by the tuner 902 into a VSB/EVSB (Vestigial Side Band/Enhanced Vestigial Side Band) signal.

The demultiplexer 904 performs demultiplexing of the signal demodulated by the demodulator 903 into the PSI/PSIP table data.

The audio-data demultiplexing and the video-data demultiplexing may be controlled by the channel manager 909. The demultiplexing of the PSI/PSIP table data may be controlled by the PSI/PSIP decoder 908.

The demultiplexed PSI/PSIP table is transmitted to the PSI/PSIP decoder 908. The demultiplexed audio/video data is transmitted to the A/V decoder 905, and the A/V decoder decodes received data.

The PSI/PSIP decoder 908 performs parsing of the PSI/PSIP section, reads all of the remaining actual section data unfiltered by the demultiplexer 904, and records the read data in the PSI/PSIP DB 907.

The channel manager 909 transmits a request for receiving the channel-associated information table by referring to the channel map 910, and receives a response to the request.

In this case, the PSI/PSIP decoder 908 controls the demultiplexing of the above-mentioned channel-associated information table, and transmits the A/V PID list to the channel manager 909.

The channel manager 909 directly controls the demultiplexer 904 using the transmitted A/D PID, such that it can control the A/V decoder 905.

The application controller 911 (i.e., Application & UI manager in FIG. 9) controls a Graphical User Interface (GUI) capable of displaying the broadcast receiver system status on the OSD (On Screen Display).

Specifically, the demultiplexer 904 according to the present invention performs demultiplexing of the EIT and others, and transmits the demultiplexed result to the PSI/PSIP decoder 908.

The EIT according to the present invention can be readily understood by the second, third, fourth, and fifth preferred embodiments. The EIT of the sixth preferred embodiment is the same as those of the second to fifth preferred embodiments.

In this case, the PSI/PSIP decoder 908 detects the EIT, such that it can acquire not only actual event information but also dummy event information.

For example, if the broadcast receiver 901 receives an EPG service request from the user, the channel manager 909 accesses the PSI/PSIP decoder 908, and receives associated information from the PSI/PSIP decoder 908.

The application controller 911 controls the display 906, and provides the user with the actual event information and the dummy event information. For example, the display 906 may display the EPG screen as shown in FIG. 2 as necessary.

In the meantime, upon receipt of dummy event information detected by the PSI/PSIP decoder 908, the application controller 909 or a PVR controller (not shown) records a specific actual event simultaneously with deleting a broadcast part of the dummy event from the recorded actual event, or may record only a specific dummy event.

### Seventh Preferred Embodiment

FIG. 10 is a flow chart illustrating a method for controlling a broadcast receiver for receiving/processing information of the EIT according to a seventh preferred embodiment of the present invention.

A method for controlling the broadcast receiver for receiving/processing the EIT according to the present invention will hereinafter be described with reference to FIGS. 10 and 1˜9.

Specifically, the seventh preferred embodiment relates to a method for controlling a broadcast receiver capable of processing the dummy event on the assumption that the dummy event associated with the advertisement broadcast event is defined.

However, if those skilled in the art refer to the first to sixth preferred embodiments and the seventh preferred embodiment, they can easily modify the method for controlling the broadcast receiver for processing other dummy events instead of the above-mentioned dummy event associated with the advertisement broadcast.

Referring to FIG. 10, the broadcast receiver receives the EIT defined separately from the dummy event at step S101.

For example, the broadcast receiver may be a DTV or an Internet TV, etc as necessary.

Upon receiving the EIT, the broadcast receiver displays the actual event information and the dummy event information on the EPG at step S102. The conventional broadcast receiver has displayed only the actual event information, resulting in greater inconvenience of the user.

The broadcast receiver determines whether a reserved viewing function of the dummy event at a specific time is established by referring to the displayed EPG screen at step S103.

If the reserved viewing function of the dummy event is established at step S103, a broadcast channel is automatically tuned to another channel for transmitting the dummy event if a current time reaches the specific time at step S104.

If the reserved viewing function of the dummy event at the specific time is not established at step S103, it is determined whether a reserved storing function of the dummy event is established by referring to the displayed EPG screen at step S105.

If the reserved storing function of the dummy event is established at step S105, the dummy event is stored in a memory or HDD of the broadcast receiver if a current time reaches the specific time at step S106.

If the reserved storing function of the dummy event is not established at step S105, it is determined whether the reserved storing function of the actual event is established by referring to the displayed EPG screen at step S107. During the reserved storing function, the remaining events other than the inserted dummy events are stored in the memory or HDD of the broadcast receiver.

If the above-mentioned reserved storing function of the actual event is established at step S107, the actual events other than the inserted dummy events are stored in the memory or HDD of the broadcast receiver if a current time reaches the specific time at step S108.

As apparent from the above description, a digital television signal, a digital television receiver, and a method for processing a digital television signal according to the present invention can define not only general broadcast programs but also undecided domains (e.g., advertisement broadcast programs, software (S/W) programs, data broadcast programs, or other transmission states having no broadcast signal, etc.) on an EPG (Electronic Program Guide) as additional events, and can easily and separately manage all the broadcast signals.

Firstly, if the inactive event status is considered to be the dummy event, the present invention can accurately recognize the start time of the active event.

Secondly, if the advertisement event status is considered to be the dummy event, the present invention can easily distinguish main broadcast programs (e.g., drama or news program) from the advertisement broadcast programs.

Thirdly, if the special-purpose data dedicated broadcast having no A/V data or the S/W download signal transmission status is considered to be the dummy event, the present invention can clearly display the event having no A/V signals on the EPG, such that it can provide the user with more diverse and precise EPG information.

It should be noted that most terminology disclosed in the present invention is defined in consideration of functions of the present invention, and can be differently determined according to intention of those skilled in the art or usual practices. Therefore, it is preferable that the above-mentioned terminology be understood on the basis of all contents disclosed in the present invention.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A digital television signal for use in a digital television receiver for receiving program and system information protocol (PSIP) data from a broadcast transmitter, the digital television signal comprising an event information table carrying information for events on defined virtual channels, wherein the event information table includes:
an event type field defining an actual event that is a collection of associated television program elements that have a common timeline for a defined period, and a dummy event that is a collection of unassociated television program elements that have a common timeline for a defined period, wherein the dummy event corresponds to an undecided domain on an electronic program guide.

2. The digital television signal of claim 1, wherein the event type field is included in a descriptor within the event information table.

3. The digital television signal of claim 1, wherein the event type field further includes information specifying types of at least two dummy events.

4. The digital television signal of claim 1, wherein the event information table further includes a title text field specifying a title of the dummy event by a text mode.

5. The digital television signal of claim 1, wherein the dummy event corresponds to an advertisement broadcast program, and indicates a specific event of transmitting the advertisement broadcast program.

6. The digital television signal of claim 1, wherein the dummy event corresponds to a broadcast program having downloadable S/W (software) signals, and indicates a specific event of transmitting the downloadable S/W signals.

7. The digital television signal of claim 1, wherein the dummy event corresponds to a broadcast program having only at least one of data service, and indicates a specific event of transmitting a data dedicated broadcast.

8. The digital television signal of claim 1, wherein the dummy event corresponds to no broadcast signal, and indicates a specific event of transmitting no broadcast signal.

9. A digital television signal for use in a digital television receiver for receiving program and system information protocol (PSIP) data from a broadcast transmitter, the digital television signal comprising an event information table carrying information for events on defined virtual channels, wherein the event information table includes:
a num events in section field defining an actual event that is a collection of associated television program elements that have a common timeline for a defined period, and a dummy event that is a collection of unassociated television program elements that have a common timeline for a defined period, wherein the dummy event corresponds to an undecided domain on an electronic program guide.

10. The digital television signal of claim 9, wherein the dummy event corresponds to at least one of an advertisement broadcast program, a broadcast program having downloadable S/W (software), a broadcast program having only at least one of data service, and no broadcast signal.

11. A digital television signal for use in a digital television receiver for receiving program and system information protocol (PSIP) data from a broadcast transmitter, the digital television signal comprising an event information table carrying information for events on defined virtual channels, wherein the event information table includes:
a title text field specifying a theme of a dummy event by a text mode, wherein the dummy event is a collection of unassociated television program elements that have a common timeline for a defined period, and corresponds to an undecided domain on an electronic program guide.

12. The digital television signal of claim 11, wherein the dummy event corresponds to at least one of an advertisement broadcast program, a broadcast program having downloadable S/W (software), a broadcast program having only at least one of data service, and no broadcast signal.

13. A digital television signal for use in a digital television receiver for receiving program and system information protocol (PSIP) data from a broadcast transmitter, the digital television signal comprising an event information table carrying information for events on defined virtual channels, wherein the event information table includes:
an event type field defining an actual event that is a collection of associated television program elements that have a common timeline for a defined period, and a dummy event that is a collection of unassociated television program elements that have a common timeline for a defined period, wherein the dummy event corresponds to at least one of an advertisement broadcast program, a broadcast program having downloadable S/W (software), a broadcast program having only at least one of data service, and no broadcast signal.

14. The digital television signal of claim 13, wherein the event type field is included in a descriptor within the event information table.

15. The digital television signal of claim 13, wherein the event type field further includes information specifying types of at least two dummy events.

16. The digital television signal of claim 13, wherein the event information table further includes a title text field specifying a title of the dummy event by a text mode.

17. A method for processing a digital television signal in a television receiver, the method comprising:
receiving a digital television signal including an event information table carrying information for events on defined virtual channels;
parsing the event information table, the parsed event information table including an event type field defining an actual event that is a collection of associated television program elements that have a common timeline for a defined period, and a dummy event that is a collection of unassociated television program elements that have a common timeline for a defined period, wherein the dummy event corresponds to an undecided domain on an electronic program guide; and
storing the parsed event information table in a database.

18. The method of claim 17, further comprising:
displaying information of the dummy event on the electronic program guide.

19. The method of claim 17, further comprising:
recording a specific actual event, and at the same time deleting an inserted dummy event part from the recorded actual event.

20. The method of claim 17, further comprising:
recording only a specific dummy event according to a user request or a user option.

21. The method of claim 17, wherein the event type field is included in a descriptor within the event information table.

22. The method of claim 17, wherein the event type field further includes information specifying types of at least two dummy events.

23. The method of claim 17, wherein the event information table further includes a title text field specifying a title of the dummy event by a text mode.

24. The method of claim 17, wherein the dummy event corresponds to at least one of an advertisement broadcast program, a broadcast program having downloadable S/W (software), a broadcast program having only at least one of data service, and no broadcast signal.

25. A method of processing a digital television signal in a television receiver, the method comprising:
receiving a digital television signal including an event information table carrying information for events on defined virtual channels;
parsing the event information table, the parsed event information table including a title text field specifying a theme of a dummy event by a text mode, wherein the dummy event is a collection of unassociated television program elements that have a common timeline for a defined period, and corresponds to an undecided domain on an electronic program guide; and
storing the parsed event information table in a database.

26. The method of claim 25, wherein the dummy event corresponds to at least one of an advertisement broadcast program, a broadcast program having downloadable S/W (software), a broadcast program having only at least one of data service, and no broadcast signal.

27. A method of processing a digital television signal in a television receiver, the method comprising:
receiving a digital television signal including an event information table carrying information for events on defined virtual channels;
parsing the event information table, the parsed event information table including a num events in section field defining an actual event that is a collection of associated television program elements that have a common timeline for a defined period, and a dummy event that is a collection of unassociated television program elements that have a common timeline for a defined period, wherein the dummy event corresponds to an undecided domain on an electronic program guide; and
storing the parsed event information table in a database.

28. The method of claim 27, wherein the dummy event corresponds to at least one of an advertisement broadcast program, a broadcast program having downloadable S/W (software), a broadcast program having only at least one of data service, and no broadcast signal.

29. A method of processing a digital television signal in a television receiver, the method comprising:
receiving a digital television signal including an event information table carrying information for events on defined virtual channels;
parsing the event information table), the parsed event information table including an event type field defining an actual event that is a collection of associated television program elements that have a common timeline for a defined period, and a dummy event that is a collection of unassociated television program elements that have a common timeline for a defined period, wherein the dummy event corresponds to at least one of an advertisement broadcast program, a broadcast program having downloadable S/W (software), a broadcast program having only at least one of data service, and no broadcast signal; and
storing the parsed event information table in a database.

30. The method of claim 29, further comprising:
displaying information of the dummy event on the electronic program guide.

31. The method of claim 29, further comprising:
recording a specific actual event, and at the same time deleting an inserted dummy event part from the recorded actual event.

32. The method of claim 29, further comprising:
recording only a specific dummy event according to a user request or a user option.

33. A digital television receiver, comprising:
a tuner arranged to receive a digital television signal including an event information table carrying information for events on defined virtual channels;
a demodulator arranged to demodulate the digital television signal;
a demultiplexer arranged to demultiplex the event information table from the digital television signal demodulated by the demodulator;
a decoder arranged to parse the event information table, the parsed event information table including an event type field defining an actual event that is a collection of associated television program elements that have a common timeline for a defined period, and a dummy event that is a collection of unassociated television program elements that have a common timeline for a defined period, wherein the dummy event corresponds to an undecided domain on an electronic program guide; and
a controller arranged to store the parsed event information table in a database.

34. The digital television receiver of claim 33, further comprising:
a display for displaying information of the actual event and information of the dummy event on the electronic program guide according to a control signal of the controller.

35. The digital television receiver of claim 33, wherein:
the controller records a specific actual event, and at the same time deletes an inserted dummy event part from the recorded actual event, or
records only a specific dummy event according to a user request or a user option.

36. The digital television receiver of claim 33, wherein the event type field is included in a descriptor within the event information table.

37. The digital television receiver of claim 33, wherein the event type field further includes information specifying types of at least two dummy events.

38. The digital television receiver of claim 33, wherein the event information table further includes a title text field specifying a title of the dummy event by a text mode.

39. The digital television receiver of claim 33, wherein the dummy event corresponds to at least one of an advertisement broadcast program, a broadcast program having downloadable S/W (software), a broadcast program having only at least one of data service, and no broadcast signal.

40. A digital television receiver, comprising:
a tuner arranged to receive a digital television signal including an event information table carrying information for events on defined virtual channels;
a demodulator arranged to demodulate the digital television signal;
a demultiplexer arranged to demultiplex the event information table from the digital television signal demodulated by the demodulator;
a decoder arranged to parse the event information table, the parsed event information table including a title text field specifying a theme of a dummy event by a text mode, wherein the dummy event is a collection of unassociated television program elements that have a common timeline for a defined period, and corresponds to an undecided domain on an electronic program guide; and
a controller arranged to store the parsed event information table in a database.

41. The digital television receiver of claim 40, wherein the dummy event corresponds to at least one of an advertisement broadcast program, a broadcast program having downloadable S/W (software), a broadcast program having only at least one of data service, and no broadcast signal.

42. A digital television receiver, comprising:
a tuner arranged to receive a digital television signal including an event information table carrying information for events on defined virtual channels;
a demodulator arranged to demodulate the digital television signal;
a demultiplexer arranged to demultiplex the event information table from the digital television signal demodulated by the demodulator;
a decoder arranged to parse the event information table, the parsed event information table including a num events in section field defining an actual event that is a collection of associated television program elements that have a common timeline for a defined period, and a dummy event that is a collection of unassociated television program elements that have a common timeline for a defined period, wherein the dummy event corresponds to an undecided domain on an electronic program guide; and
a controller arranged to store the parsed event information table in a database.

43. The digital television receiver of claim 42, wherein the dummy event corresponds to at least one of an advertisement broadcast program, a broadcast program having downloadable S/W (software), a broadcast program having only at least one of data service, and no broadcast signal.

44. A digital television receiver, comprising:
a tuner arranged to receive a digital television signal including an event information table carrying information for events on defined virtual channels;
a demodulator arranged to demodulate the digital television signal;
a demultiplexer arranged to demultiplex the event information table from the digital television signal demodulated by the demodulator;
a decoder arranged to parse the event information table, the parsed event information table including an event type field defining an actual event that is a collection of associated television program elements that have a common timeline for a defined period, and a dummy event that is a collection of unassociated television program elements that have a common timeline for a defined period, wherein the dummy event corresponds to at least one of an advertisement broadcast program, a broadcast program having downloadable S/W (software), a broadcast program having only at least one of data service, and no broadcast signal; and
a controller arranged to store the parsed event information table in a database.

45. The digital television receiver of claim 44, further comprising:
a display for displaying information of the actual event and information of the dummy event on the electronic program guide according to a control signal of the controller.

46. The digital television receiver of claim 44, wherein:
the controller records a specific actual event, and at the same time deletes an inserted dummy event part from the recorded actual event, or records only a specific dummy event according to a user request or a user option.
